(19) United States
(12) Patent Application Publication
(10) Pub. No.: US 2022/0351138 A1
(43) Pub. Date: Nov. 3, 2022

(54) NETWORKED ONBOARDING SYSTEM WITH ACCELERATOR AND REQUEST FOR AMENDMENT FUNCTIONS

(71) Applicant: MARKIT NORTH AMERICA, INC., New York, NY (US)

(72) Inventors: Brittany Garland, Ridgewood, NJ (US); Darren Thomas, Rye, NY (US); Michelle Ruggiero, Randolph, NJ (US); Manika Rastogi, Eastchester, NY (US); Vikrant Nishandar, Woodridge, NJ (US)

(21) Appl. No.: 17/245,582

(22) Filed: Apr. 30, 2021

(51) Int. Cl. G06Q 10/10; G06Q 50/18; G06F 16/93

(52) U.S. Cl. CPC G06Q 10/10; G06Q 50/18; G06F 16/93; G06Q 40/025

(57) ABSTRACT

A networked onboarding system that includes an onboarding accelerator (OA) and a request for amendment (RFA) module or application. The onboarding accelerator is a software solution or algorithm that is configured to operate to provide an automated and customizable end-to-end onboarding solution for users or subscribers (e.g., brokers, custodians, corporations, fund administrators, managers, service providers, and the like). The onboarding accelerator functions during client onboarding to integrate entity data, document collection, KYC (know your customer) and tax profile validation, regulatory protocols and self-declarations, legal and credit agreements, and operational set up into a seamless solution. The RFA module operates to enable a user or subscriber to initiate and execute amendments to add, remove, and modify legal entities (e.g., counterparty amendments) from its existing trading agreements with other subscribers to the services provided by the new onboarding system.

### BACKGROUND

### 1. Field of the Description

The present description relates, in general, to data processing and storage systems provided in a digitized and networked manner (or that are based in the cloud, and, more particularly, to a network or cloud-based system that is adapted to provide enhanced and streamlined (or accelerated) onboarding of new clients or accounts and processing of legal amendment letters, a request for amendment, of such onboarded accounts in ways that manage risk and provide full regulatory compliance.

### 2. Relevant Background

There is an ongoing demand for new systems, and software applications or algorithms, for better supporting and more smoothly handling the new account onboarding or, more generally, the onboarding process or client onboarding. Many in the financial industry, for example, believe it is one of the most pressing challenges and needs improvement or even fixing. Client onboarding is a process by which a market participant determines via examination of related risks whether or not it wishes to do business with a counterparty.

Presently, onboarding is a largely manual process that is time-consuming, expensive, and error-prone. In many cases, financial service providers have experienced it taking 30 to 40 or more days to onboard a new account and deploy capital. This is due to the manual nature of existing onboarding processes as well as other issues such as a lack of industry standardization, transparency and controls, use of manual communications, and changing requirements across institutions.

Even with the demands across the financial industry for improved onboarding processes, no quick fix has yet been identified and implemented successfully. One of the stumbling blocks has been the rapid growth in the amount of data available that has to be processed to provide trusted onboarding of clients. Some attempts to improve the process have involved creating deployed software solutions that companies can utilize to facilitate their internal onboarding process. However, these are typically standalone applications, which have not been widely adopted such that their remains a lack of standardization and a need for manual communications and data entry.

### SUMMARY

Briefly, a network or cloud-based (or networked) system is provided to address these and other problems by providing a new onboarding accelerator along with, in some embodiments, a request for amendment (RFA) module (or application or app). The onboarding accelerator and RFA module are configured to digitize and streamline the onboarding process across asset owners, corporations, corporate banks, investment managers, broker dealers, custodians, and third parties.

The inventors recognized that the networked system can be designed to provide a solution that is the connector across the financial services industry. All deployed software solutions or applications (e.g., at the various entities involved with or providing the client onboarding) can be hooked up to (e.g., communicatively linked with) the onboard accelerator, which acts as the central location for data aggregation, data distribution, and transparency throughout the onboarding process. The system may be configured to integrate all the components of the counterparty manager platform and its technologies for file sharing (which is described in U.S. Pat. No. 9,959,367, which is incorporated herein in its entirety by reference, as a third party centralized data hub) while also automating the legal amendment process through integration with the RFA module.

More particularly, a networked onboarding system is provided to streamline new account onboarding and responses to requests for amendment (RFAs). The system includes data storage storing a set of entity data and a plurality of document templates each defining a legal agreement between two or more entities. Further, the system includes a computing device (e.g., a server or application box) with a processor. The computing device is communicatively linked to a plurality of client devices via a digital communication network, and the processor executing code to provide an onboarding accelerator performing the following steps: (a) prompting a user of one of the client devices to enter data for an account or to apply that via in the form of an account profile; (b) in response to input from the user, uploading one of the document templates; (c) processing the data for the account to determine an entity authorized to trade on the account; (d) populating an onboarding request using the one of the document templates, the data for the account, the entity authorized to trade on the account, and additional data retrieved from the set of entity data based on the data for the account; and (e) transmitting the onboarding request to the user for review and submittal for processing by the onboarding accelerator.

In some embodiments, the processor further executes code to provide a request for amendment (RFA) utility that automatically generates a legal amendment letter in response to receipt of the onboarding request from the user. During system operations, the RFA utility transmits the amendment letter to the client device operated by the user and prompts the user to review and execute the amendment letter electronically or physically. Also, the RFA utility receives the amendment letter after execution by the user and transmits the amendment letter received from the user to the entity (or entities) authorized to trade on the account via the digital communication network. Still further, the system is configured such that the user and the entity authorized to trade on the account are provided access to data related to the onboarding request via communications with the onboarding accelerator.

In the same or other embodiments of the new system, prior to the populating of the onboarding request, the onboarding accelerator receives a selection of instruments to be traded on the account from the user and, in response, the onboarding accelerator retrieves and populates with the set of entity data a set of trading agreements associated with the selection of instruments. Also, the document templates in the system (e.g., ones used during onboarding and/or that are amended by the RFA utility) include templates for two or more of the following document types: (a) an ISDA (International Swaps and Derivatives Association) Master Agreement; (b) a Credit Support Annex (CSA); (c) an MRA/GMRA (Master Repurchase Agreement/Global Master Repurchase Agreement); (d) a CDEA (Cleared Derivatives Execution Agreement); (e) a futures/options agreement; (f) an FX (foreign exchange) letter; (g) a representations and warranties document; (h) a MSFTA (Master Securities Forward Transaction Agreement); (i) an MSLA/GMSLA (Master Securities Lending Agreement/Global Master Securities Lending Agreement); (j) an MCA (Master Confirmation Agreement); (k) an ACA (Account Control Agreement); (l) a Bilateral Dodd Frank Protocol Agreement; (m) a custodial undertaking agreement; (n) a custody agreement; and (o) an account control agreement.

### BRIEF DESCRIPTION OF THE DRAWINGS

FIG. 1 illustrates an exemplary cloud-based or networked onboarding system with an onboarding accelerator and RFA module/utility of the present description;

FIG. 2 is a process flow diagram showing integration of the onboarding method carried out by the Onboarding Accelerator with the amendment method provided by RFA module/utility during operations of the system of FIG. 1;

FIG. 3 is a flow diagram of an onboarding method as may be carried out as part of or instead of steps of the onboarding method of FIG. 2; and

FIG. 4 is a flow diagram of another portion of an onboarding method as may be carried out by the system of FIG. 1 including handling of RFAs.

### DETAILED DESCRIPTION OF THE PREFERRED EMBODIMENTS

Briefly, the following description describes a networked onboarding system that includes an Onboarding Accelerator (OA) and a Request for Amendment (RFA) module or application. The onboarding accelerator is a software solution or algorithm that is configured to operate to provide an automated and customizable end-to-end onboarding solution for users or subscribers (e.g., brokers, custodians, corporations, fund administrators, managers, service providers, and the like). It can be provided within the onboarding system so as to be built within the counterparty manager platform (described in U.S. Pat. No. 9,959,367, which is incorporated herein in its entirety by reference, as a third party centralized data hub), and the onboarding accelerator functions during client onboarding to integrate entity data, document collection, KYC (know your customer) and tax profile validation, regulatory protocols and self-declarations, legal and credit agreements, and operational set up into a seamless solution.

The RFA module operates to enable a user or subscriber to initiate and execute amendments to add, remove, and modify legal entities and/or trading accounts (e.g., counterparty amendments) from its existing trading agreements with other subscribers to the services provided by the new onboarding system. The agreements (or agreement types) that may be amended by the RFA module may vary to practice the new system but may include: (a) an ISDA (International Swaps and Derivatives Association) Master Agreement; (b) a Credit Support Annex (CSA); (c) an MRA/GMRA (Master Repurchase Agreement/Global Master Repurchase Agreement); (d) a CDEA (Cleared Derivatives Execution Agreement); (e) a futures/options agreement; (f) an FX (foreign exchange) letter; (g) a representations and warranties document; (h) a MSFTA (Master Securities Forward Transaction Agreement); (i) an MSLA/GMSLA (Master Securities Lending Agreement/Global Master Securities Lending Agreement); (j) an MCA (Master Confirmation Agreement); (k) an ACA (Account Control Agreement); (l) a Bilateral Dodd Frank Protocol Agreement; (m) a custodial undertaking agreement; (n) a custody agreement; and (o) future additional or different document types as agreed between the parties (e.g., the users or subscribers of the new system).

During system operations, the onboarding accelerator, connected and working with the RFA module, automates the creation of legal amendment letters. To this end, the onboarding accelerator retrieves from data storage, which is coupled to the network on which the server(s) running the onboarding accelerator and/or the RFA module, entity data, counterparty relationships, and transaction types that will occur on the user's or subscriber's account (i.e., the client account being onboarded by the system). The information about the account and relationships on or assigned to the account are used by the onboarding accelerator and/or RFA module to systemically identify the correct legal agreement for the account to be added to and then to auto-populate attributes directly in the legal amendment letter.

As will become clear from the following description, the onboarding accelerator is designed or configured to provide a number of unique functions or operating features. The onboarding accelerator provides connectivity to other components of the new system to streamline onboarding, and these may be all the components of the counterparty manager platform or third party centralized hub (e.g., the RFA module, the ISDA amendment module, the tax utility, the KYC utility, Outreach360, the request tracker, AUM/NAV information, and entity and document repositories). Additionally, connectivity is provided to other trading and settlement platforms (e.g., 360T, MSERV, ClearPar, and the like), data services (e.g., Big Dough, GLEIF, and the like), as well as to analytical services (e.g., Tableau Analytics).

Additionally, the onboarding accelerator is adapted such that receivers of onboarding requests can indicate their onboarding requirements, which are matched based off the type of account, type of trading, and jurisdiction of both parties to indicate, and inclusive of the receiver's required data points, documents, and any questions, through an onboarding policy builder. In some cases, the policy builder supports custom questions, and there is a robust policy matching engine that systemically auto matches the policy. Further, the onboarding accelerator provides the ability for receivers of onboarding requests to provide information (e.g., account codes, documentation, and the like) back to the originator of the onboarding request. Still further, the onboarding accelerator may be configured to allow receivers of onboarding requests to set up customized workflows that, in some cases, mimic the steps they are following internally during the account open process and are based on the parameters of the request (e.g., the type of account, the type of trading which will occur on the account, and the jurisdiction of both parties). Throughout such a process, the receivers of the onboarding requests can then provide transparency (e.g., to the originator of the onboarding request) as to which steps of onboarding are complete, in progress, or rejected as this information can be made visible to the sender of the onboarding request (e.g., in a graphical user interface (GUI) created and presented on one of their client devices communicatively linked to the onboard accelerator). Note, there may be multiple workflows, and the process may be configured to link the policy to trigger a specific workflow based on specific parameters of the received request (e.g., they can determine a policy/workflow based on transaction type (e.g., product) while in the same or other cases these workflows can be linked to the Request for Amendment platform to track the updates/statuses directly between the platforms).

Similarly, as will become clear from the following description, the RFA module (or the performed algorithm(s)) is designed or configured to provide a number of unique functions or operating features. The RFA module creates and uses stored letter templates to allow users to re-use the same legal amendment letters, which are populated by the RFA module using place holders that are automatically populated with the entity information from the entities selected via interaction with the onboarding accelerator and/or the RFA module during system operations. The RFA module creates and manages a central repository of letter templates. The RFA module further is designed to provide automatic updates and storage of all entity data and legal information related to an account, which has been added, removed, or modified as a party of an agreement. Additionally, the RFA module is adapted to function to provide the ability for receivers of the onboarding requests to provide real-time updates as the request is processed or if the account requires additional information from the client (e.g., requestor or sender of onboarding request).

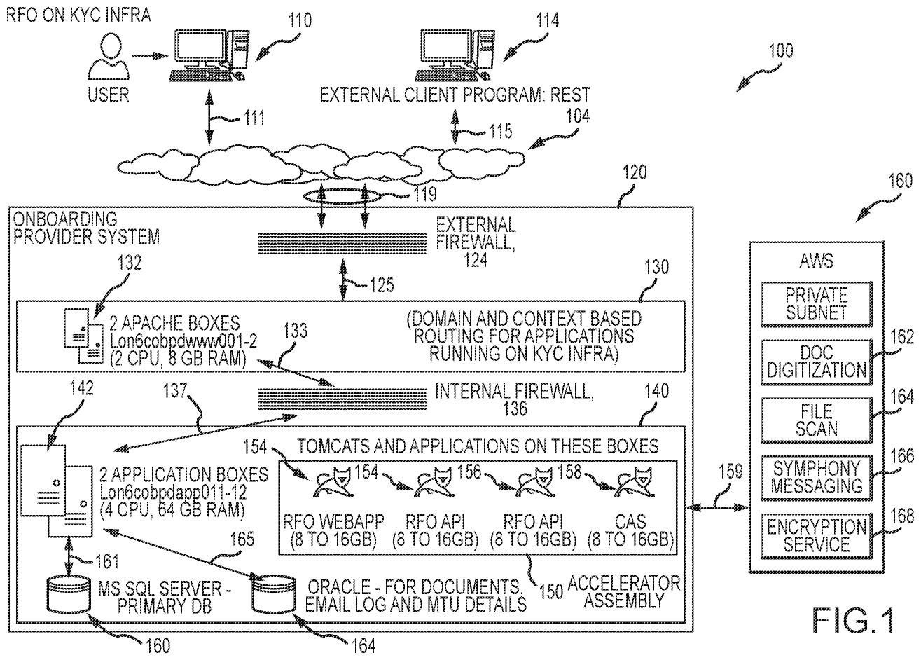

FIG. 1 illustrates an exemplary cloud-based or networked onboarding system 100 with an onboarding accelerator 154 and RFA module/utility 156 of the present description. It will be understood by those skilled in the arts that the system 100 may take a variety of forms to implement the data processing and networked communication features, with the system 100 only being one useful but non-limiting example. As shown, the system 100 is a computer architecture that is useful for supporting a request for onboarding (RFO) within an existing but modified know-your-client (KYC) infrastructure.

An onboarding provider system (or computer network) 120 is included in the system 100 and is communicatively linked (in a wireless and/or wired manner) as shown with arrows 119 with a digital communications network 104 (e.g., the Internet or Cloud). Users 102 may operate their client systems/device 110 to communicate with the system 120 as shown with arrows 111 to request initiation of an onboarding of a new client and/or amendment of contract or legal document. The systems/device 110 may take the form of nearly any computing device with one or more monitors and/or input/output (I/O) devices to allow the users 102 to interact with onboarding and amendment date such as via a displayed GUI(s) and a touchscreen, a mouse, a keyboard, and voice input components. Other users (such as responders to onboarding requests) may operate a similar computing system/device 114 (such as one with a REST program (representational state transfer or other web app)) to communicate with the system 120 via the cloud/network 104 as shown with arrows 115 so as to receive requests for data, respond to such requests, and view onboarding or amendment data produced by the system 120.

To facilitate secure communications with the devices 110, 114, the system 120 may include an external firewall 124 processing the communications 119 that are passed to a routing assembly 130 with computing boxes (with hardware and software) 132 configured to provide domain and context-based routing for applications (such as applications 154 and 156) running on the system 120. These routed communications 133 are provided to an internal firewall 136 to provide further security for system 120 and then, as shown with arrows 137, passed to the accelerator assembly 140. As shown with arrows 159, communications with the devices 110, 114 and/or collection and processing of data (e.g., by the onboarding accelerator 154 and the RFA utility 156) may be facilitated through use of a web services platform 160, which is shown to provide cloud-based services including document digitization 162, file scanning 164, messaging 166, and encryption service 168. An authentication service or utility 158 may be provided as part of the software suite 150, such as Apache Tomcat CAS or the like, to provide a sign-on solution for the users 102 using the systems/devices 110, 114 to access the onboarding accelerator 154 and/or RFA utility/module 156.

As shown, the accelerator assembly 140 includes one or more processors 142 (shown as part of application boxes) running code/instructions or software to provide the functions of the onboarding accelerator 154 and the RFO utility 152. The processors 142 may manage data storage/memory utilized by the software suite 150 including retrieval and storage of data, as shown with arrows 161 and 165, by the onboarding accelerator 154 and the RFA utility 156 from a database(s) on storage device(s) 160 and from a data file system 164 used to store documents, communications (e.g., an e-mail log), MTU details (e.g., tax-id, entity address, and so on), and the like.

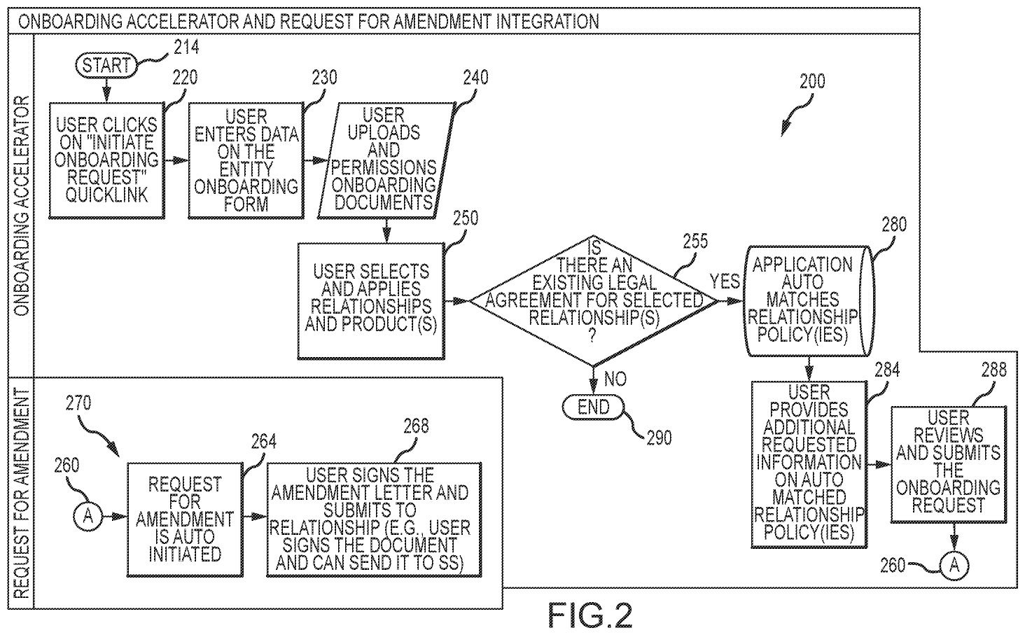

With this understanding of a useful architecture of a system 100 for providing enhanced client onboarding, it may be useful to describe process flow to carry out the onboarding and responses to requests for amendment. FIG. 2 is a process flow diagram 200 showing integration of the onboarding method 210 carried out by the onboard accelerator with the amendment method 270 provided by RFA module/utility during operations of the system 100 of FIG. 1. The onboarding method 210 carried out by the accelerator begins at 214 such as with establishing communication links and/or connectivity between a client device 110 operated by a user 102 and an onboarding provider system 120 (as seen in FIG. 1). In some cases, this step 214 may involve downloading a web app at the device/system 110.

The onboarding method 210 continues at 220 with the user providing input to initiate a client onboarding request. This may involve the user 102 interacting with a GUI displayed on the device/system 110 to provide input 111, such as by clicking on a link (e.g., an “Initiate Onboarding Request” quicklink). The onboarding method 210 then proceeds with step 230 which involves providing entity/client data for the entity/client associated with the onboarding request (which is again communicated as shown with arrows 111 and 119 in FIG. 1 to the system 120 for processing by the onboard accelerator 154). This data may be stored in data storage 160 and/or 164 for later use by the software suite 150.

Next, in step 240, the user 102 operates their device 110 to upload and permission onboarding documents. In this step 240, the onboarding accelerator 154 may first display a list of onboarding documents for selection by the user 102, and, in response to selections, upload the selected onboarding documents. In other cases, a default set of onboarding documents will be retrieved by the accelerator 154 from the database 160 or file system 164. In step 250, the onboarding accelerator 154 via a GUI on device 110 prompts the user 102 to select and apply relationships and products to the new client/entity for the present onboarding transaction.

In response, as shown at 255 in FIG. 2, the onboarding accelerator 154 determines whether or not there is an existing legal agreement for the selected relationship. If not, the method 210 may end at 290. If yes, the method 210 moves to step 260 with initiation of the RFA module/utility 156 as shown with amendment method 270 in FIG. 2. At step 264, the RFA module/utility 156 auto initiates the request for amendment to the existing legal agreement from step 255 (which may be retrieved from that database of storage device 160), and this may include generating an amendment letter for the legal agreement. Then, at step 268, the RFA module/utility 256 acts to prompt the user 102 on device 110 and/or device 114 to sign the amendment letter (e.g., via electronic signature or the like). The amendment letter is then submitted to the relationship for use by the onboarding accelerator 154 in performing the onboarding method 210.

Particularly, after step 268 is completed, the method 210 continues at 280 with the onboard accelerator 154 automatically matching relationship policies defined in (stored in) data storage 160 and/or 164 and using this information to update the onboarding data. The onboarding method 210 continues at step 284 with accelerator 154 prompting the user to provide additional (e.g., any missing information from a template or form) information on the auto-matched relationship policies. In step 284, the onboarding accelerator 154 receives this data and acts to update the set of onboarding data stored in storage 160 and/or 164. This may involve creating and/or populating the digital onboarding request. Then, at step 288, the onboarding accelerator prompts the user 102 to review the onboarding request, which has been provided to their device 110 (via an electronic file and/or via display in a GUI on a monitor of the device 110). If acceptable, the user 102 then submits the onboarding request to the onboarding accelerator 154 and system 120.

At this point in the description, it may be useful to further explain the functionality of the new system 100 by explaining portions of the process flow 200 in further detail. Step 220 typically involves the client logging into the onboard accelerator platform 120 because they are launching a new fund, creating a new account, or managing a new client account. In step 220, the user accesses the platform 120 with the onboard accelerator 154 generating/providing a GUI, and the user may click on “Initiate Onboarding Request” or another such link provided in the accelerator GUI.

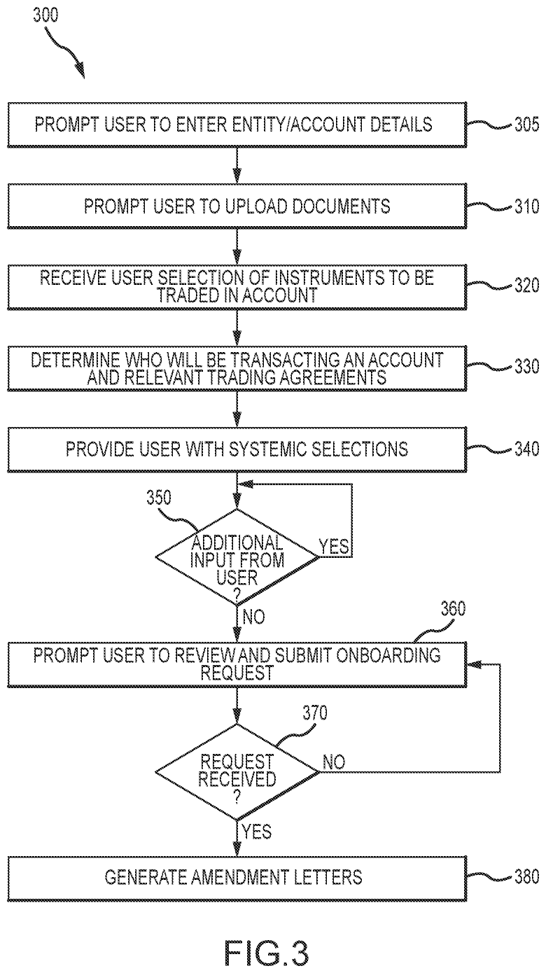

In response, the onboarding accelerator 154 may carry out the onboarding process 300 shown in FIG. 3 (which may be considered a restatement and/or expansion of steps 230, 240, 250, 266, 280, 284, and 288 of FIG. 2). In step 305, the onboarding accelerator prompts the user to enter entity and/or account information/details (e.g., via operation of the displayed GUI to the accelerator 154), and this input is received and stored by the accelerator 154 for later use in the method 300. As part of step 305, the user may enter: (a) an entity or account name; (b) an entity or account domicile; (c) an entity or account type; and (d) additional entity details such as an entity/account identifier and ad-hoc/custom fields determined useful by the user. Then, in step 310, the onboard accelerator 154 acts to identify a set of documents that may be relevant to the onboarding process and to prompt the user to select and upload these documents for use in onboarding. As noted above, these documents may be any of a number of documents used today or in the future in onboarding such as tax forms, entity formation documents, and so on.

After the selected documents are uploaded, the method 300 continues at 320 with prompting the user for and receiving selection of instruments to be traded on the account associated with the onboarding. In step 320, the user progresses to indicating what instruments will be traded on the account and also with whom they will be trading. An example would be to receive user input indicated that a new account will be trading derivatives, repo, and case with a list of one-to-many financial institutions and/or banks.

The onboarding platform 120 with accelerator 154 then acts at 330 to determine who will be transacting on the account and to identify the relevant trading agreements needed for proper onboarding. In some cases, the system/platform 120 retrieves the entity data from step 305 and who/what will be transacting on the account from the input of step 320, and then the system/platform 120 in step 330 acts to determine that the account will need to be added to the relevant trading agreements. For example, because derivatives will be traded on the account, the account may need to be added to the ISDA/CSA Master Agreement with the banks indicated (e.g., the “whom” from step 320). As another example, because repo will be traded on the account, the account may need to be added to the Master Repurchase Trading Agreement with the banks indicated (again, the “whom” from step 320). Significantly, in current onboarding practices that are without the connectivity provided by the new onboarding accelerator 154, the user would need to know which trading agreements needed to be updated and would have to choose those trading agreements manually.

After the system/platform 120 determines which trading agreements need to be updated, the system 120 in step 340 can provide these systemic selections to the user (in their GUI or the like) for review and approval. Step 350 involves the system 120 requesting, if needed (e.g., missing data from agreements that need to be updated with the account), additional information from the user. Again, this information may be provided in a GUI or other manner by the user for processing by the onboarding accelerator 154 and may include information about the account based on the transactions and which bank relationships are selected. Once all additional information is input and received by the system/platform 120, the method 300 continues with step 360.

In step 360, the user is provided the onboarding request and prompted to complete review and submit the system-generated onboarding request. Once the request is received at step 370, the system/platform 120 at step 380 acts (e.g., via calling the RFA module/utility 156) to generate amendment letters, which may be legal letters that state “this account is hereby added to the ISDA Master Agreement” or the like. The system-generated letter may include data points about the account that are automatically populated by the system 120 based on the user's inputs (e.g., from step 305).

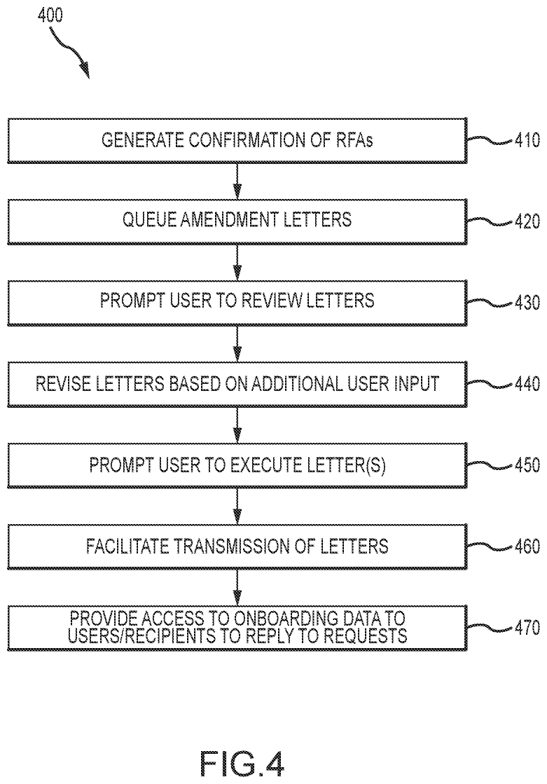

FIG. 4 is a flow diagram of another portion of an onboarding method 400 as may be carried out by the system 100 of FIG. 1 including handling of RFAs (by accelerator 154 and/or by RFA utility 156). The method 400 may begin upon the completion of step 380 of method 300 of FIG. 3. In step 410, the system 120 generates a confirmation of the generated amendment letters or RFAs. This may involve generating a confirmation message to advise the user (party/entity that submitted the onboarding request) of the legal letters (or RFAs) that have been successfully generated (e.g., in step 380 of method 300), and typically have been stored in data storage 160 (or storage 164 in some cases). In step 420, the system 120 queues the letters. In some preferred embodiments, the system 120 does not automatically send the letters/RFAs to the entities (e.g., bank relationships) previously selected by the user (but this can be done in some implementations when appropriate or desired).

In step 430, the system 120 prompts the user (e.g., via a displayed GUI) to review the generated letters/RFAs. In step 430, the user reviews each of the amendment letters, and, in response, the user may provide additional input/changes, which the system in step 440 uses to revise the letters/RFAs. For example, the inputs of step 430 may include any be-spoke data points (e.g. those that were not automatically generated from pre-population by the system 120 in step 380 of method 300 of FIG. 3). Then, in step 450, the system 120 prompts the user 102 (again via updates to the GUI, via messaging, or the like) to execute the letters/RFAs. Typically, the user, once satisfied with a letter/RFA, must execute the letter. To this end, the user may communicate with the system 120 to download, print, and physically sign the letter/RFA. In other cases, the user may act to electronically or digitally sign the letter/RFA as part of its execution.

The method 400 then continues at step 460 with the system 120 facilitating transmission of the user-executed letters/RFAs. In practice, once the letters/RFAs are signed, the user can then “send” the letters/RFAs. In this regard, the onboarding accelerator 154 and/or RFA utility 156 may be configured to generate an e-mail notification to the relevant entities (e.g., bank users) for the user 102 to use in transmitting the letters/RFAs. Then, in step 470, the system 120 functions to provide access to onboarding data (e.g., in storages 160 and/or 161) to users/recipients to facilitate completion of the onboarding process (e.g., to facilitate replies to requests for onboarding and/or to replying to RFAs). In step 470, the users can log in to the platform 120 and reply to the request for onboarding. The platform/system 120 may be configured to display all updates to the letter/RFA (such as in an onboarding GUI, which may be provided in the onboarding provider system or accelerator platform 120). The system 120 may also provide a central location to track counter signatures and act to aggregate (e.g., in storage 160) all legal letters associated with the onboarding request in a central repository of entity data, entity documents, and the legal agreements for which the entity is a party.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, with regard to draft workflow, users can add in additional bespoke language as required. All proposed language is tracked, audited, and must be agreed upon by both parties to be included within the final version of the document.

The new onboarding system differs from other solutions in that it does not simply address one specific component useful in the onboarding process. Instead, the system brings each step of the onboarding process together. The new system or platform provides a holistic picture that incorporates output of data management (or third party centralized hub) components (e.g., the data output from KYC, tax, credit, legal, regulatory, and operation utilities and the like) to give the end user the ability to see when they are ready to transact on any account that is processed (onboarded) through the new system/platform. The new system/platform provides a single location for a user or customer to see their entity data across platforms, with the onboarding accelerator processing requests for onboarding and the RFA module or utility processing agreements associated with (or appropriate to) the onboarding request.

We claim:

1. A networked onboarding system, comprising:
data storage storing a set of entity data and a plurality of document templates each defining a legal agreement between two or more entities;
a computing device with a processor, the computing device being communicatively linked to a plurality of client devices via a digital communication network and the processor executing code to provide an onboarding accelerator performing the following steps:
prompting a user of one of the client devices to enter data for an account;
in response to input from the user, uploading one of the document templates;
processing the data for the account to determine an entity authorized to trade on the account;
populating an onboarding request using the one of the document templates, the data for the account, the entity authorized to trade on the account, and additional data retrieved from the set of entity data based on the data for the account;
transmitting the onboarding request to the user for review and submittal for processing by the onboarding accelerator.

2. The system of claim 1, wherein the processor further executes code to provide a request for amendment (RFA) utility that automatically generates an amendment letter in response to receipt of the onboarding request from the user.

3. The system of claim 2, wherein the RFA utility transmits the amendment letter to the client device operated by the user and prompts the user to review and execute the amendment letter.

4. The system of claim 3, wherein the RFA utility receives the amendment letter after execution by the user and transmits the amendment letter received from the user to the entity authorized to trade on the account via the digital communication network.

5. The system of claim 4, wherein the user and the entity authorized to trade on the account are provided access to data related to the onboarding request via communications with the onboarding accelerator.

6. The system of claim 1, wherein, prior to the populating of the onboarding request, the onboarding accelerator receives a selection of instruments to be traded on the account from the user and, in response, the onboarding accelerator retrieves and populates with the set of entity data a set of trading agreements associated with the selection of instruments.

7. The system of claim 1, wherein the document templates include templates for two or more of the following document types: (a) an ISDA (International Swaps and Derivatives Association) Master Agreement; (b) a Credit Support Annex (CSA); (c) an MRA/GMRA (Master Repurchase Agreement/Global Master Repurchase Agreement); (d) a CDEA (Cleared Derivatives Execution Agreement); (e) a futures/options agreement; (f) an FX (foreign exchange) letter; (g) a representations and warranties document; (h) a MSFTA (Master Securities Forward Transaction Agreement); (i) an MSLA/GMSLA (Master Securities Lending Agreement/Global Master Securities Lending Agreement); (j) an MCA (Master Confirmation Agreement); (k) an ACA (Account Control Agreement); (l) a Bilateral Dodd Frank Protocol Agreement; (m) a custodial undertaking agreement; (n) a custody agreement; and (o) an account control agreement.

8. A networked onboarding system, comprising:
data storage storing a set of entity data and a plurality of document templates each defining a legal agreement between two or more entities; and
a request for amendment (RFA) module running on an application box communicatively linked to the data storage,
wherein the RFA module automatically generates an amendment letter using one of the document templates and in response to receipt of an onboarding request from an operator of a client device communicatively linked over a communications network to the application box, and
wherein the RFA module transmits, over the communications network, the amendment letter to the operator of the client device and prompts the operator to review and execute the amendment letter.

9. The system of claim 8, wherein the RFA utility receives the amendment letter after execution by the operator and transmits, via the communications network, the amendment letter received from the operator to an entity authorized to trade on an account defined in the onboarding request.

10. The system of claim 9, wherein the operator and the entity authorized to trade on the account are provided access to data related to the onboarding request via communications with the application box.

11. The system of claim 8, further comprising an onboarding accelerator running on the application box and wherein the onboarding accelerator receives a selection of instruments to be traded on the account from the operator and, in response, the onboarding accelerator retrieves and populates with the set of entity data a set of trading agreements associated with the selection of instruments.

12. The system of claim 8, wherein the document templates include templates for two or more of the following document types: (a) an ISDA (International Swaps and Derivatives Association) Master Agreement; (b) a Credit Support Annex (CSA); (c) an MRA/GMRA (Master Repurchase Agreement/Global Master Repurchase Agreement); (d) a CDEA (Cleared Derivatives Execution Agreement); (e) a futures/options agreement; (f) an FX (foreign exchange) letter; (g) a representations and warranties document; (h) a MSFTA (Master Securities Forward Transaction Agreement); (i) an MSLA/GMSLA (Master Securities Lending Agreement/Global Master Securities Lending Agreement); (j) an MCA (Master Confirmation Agreement); (k) an ACA (Account Control Agreement); (l) a Bilateral Dodd Frank Protocol Agreement; (m) a custodial undertaking agreement; (n) a custody agreement; and (o) an account control agreement.

13. A networked onboarding system, comprising:
data storage storing a set of entity data and a plurality of onboarding documents;
a computing device with a processor, the computing device being communicatively linked to the data storage and the processor executing code to provide an onboarding accelerator and an RFA utility,
wherein the onboarding accelerator:
prompting a user of a client device communicatively coupled to the computing device to enter data in an entity onboarding form displayed on the computing device;
in response to the user entering the data, uploading one or more of the onboarding documents populated by the onboarding accelerator using the set of entity data and the data entered in the entity onboarding form;
receiving a relationship selection from the user; and
determining whether there is an existing legal agreement for the relationship selected by the user; and
wherein the RFA utility is called when the existing legal agreement is identified and, in response, generates a request for amendment associated with the existing legal agreement.

14. The system of claim 13, wherein the onboarding accelerator further automatches a set of policies based on the relationship selected by the user, prompts the user for additional information defined by the set of policies, and generates an onboarding request based on the additional information and the set of policies for submittal to the onboarding accelerator by the user.

15. The system of claim 13, wherein the RFA utility transmits the request for amendment to the client device operated by the user and prompts the user to review and execute the request for amendment.

16. The system of claim 15, wherein the RFA utility receives the request for amendment after execution by the user and transmits the request for amendment received from the user to an entity authorized to trade on an account associated with the onboarding request.

17. The system of claim 16, wherein the user and the entity authorized to trade on the account are provided access to data related to the onboarding request via communications with the onboarding accelerator.

18. The system of claim 16, wherein, prior to populating of the onboarding request, the onboarding accelerator receives a selection of instruments to be traded on the account from the user and, in response, the onboarding accelerator retrieves and populates with the set of entity data a set of trading agreements associated with the selection of instruments.

19. The system of claim 13, wherein the existing legal agreement is selected from the group of agreements consisting of: (a) an ISDA (International Swaps and Derivatives Association) Master Agreement; (b) a Credit Support Annex (CSA); (c) an MRA/GMRA (Master Repurchase Agreement/Global Master Repurchase Agreement); (d) a CDEA (Cleared Derivatives Execution Agreement); (e) a futures/options agreement; (f) an FX (foreign exchange) letter; (g) a representations and warranties document; (h) a MSFTA (Master Securities Forward Transaction Agreement); (i) an MSLA/GMSLA (Master Securities Lending Agreement/Global Master Securities Lending Agreement); (j) an MCA (Master Confirmation Agreement); (k) an ACA (Account Control Agreement); (l) a Bilateral Dodd Frank Protocol Agreement; (m) a custodial undertaking agreement; (n) a custody agreement; and (o) an account control agreement.
